(19) United States
(12) Patent Application Publication
(10) Pub. No.: US 2026/0358881 A1
(43) Pub. Date: Nov. 12, 2026

(54) OBJECT IDENTIFICATION USING HAND DATA

(71) Applicant: GOOGLE LLC, Mountain View, CA (US)

(72) Inventors: Mahdi Tayarani Najaran, Oakville (CA); Ruofei Du, San Francisco, CA (US)

(21) Appl. No.: 19/200,192

(22) Filed: May 6, 2025

(51) Int. Cl. G06F 3/01; G06T 11/00; G06V 10/70; G06V 20/20; G06V 40/10

(52) U.S. Cl. CPC G06F 3/011; G06T 11/00; G06V 10/70; G06V 20/20; G06T 2200/24; G06V 40/11

(57) ABSTRACT

A method includes receiving an indicator of an orientation of a hand of a user. The method further includes identifying, based on the indicator, that the user is interacting with a real-world object. The method further includes determining, based on the indicator, a characteristic of the real-world object. The method further includes generating a virtual object related to the real-world object and the characteristic. The method further includes associating the virtual object with the real-world object.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices include glasses, headsets, or screens equipped with sensors, cameras, and displays that utilize the movement of users and their surroundings to deliver immersive experiences across various applications such as gaming, education, healthcare, on-the-go computing, and industrial training.

### SUMMARY

In an aspect, a method includes receiving an indicator of an orientation of a hand of a user. The method further includes identifying, based on the indicator, that the user is interacting with a real-world object. The method further includes determining, based on the indicator, a characteristic of the real-world object. The method further includes generating a virtual object related to the real-world object and the characteristic. The method further includes associating the virtual object with the real-world object.

In another aspect, a computing system includes a computer-readable storage media, at least one processor operatively coupled to the computer-readable storage media, and program instructions stored on the computer-readable storage media that. When the program instructions are executed by the at least one processor, the at least one processor is directed to perform a method. The method includes receiving an indicator of an orientation of a hand of a user. The method further includes identifying, based on the indicator, that the user is interacting with a real-world object. The method further includes determining, based on the indicator, a characteristic of the real-world object. The method further includes generating a virtual object related to the real-world object and the characteristic. The method further includes associating the virtual object with the real-world object.

In another aspect, a computer-readable storage medium has program instructions stored thereon. When the program instructions are executed by at least one processor, direct the at least one processor to perform a method. The method includes receiving an indicator of an orientation of a hand of a user. The method further includes identifying, based on the indicator, that the user is interacting with a real-world object. The method further includes determining, based on the indicator, a characteristic of the real-world object. The method further includes generating a virtual object related to the real-world object and the characteristic. The method further includes associating the virtual object with the real-world object.

### BRIEF DESCRIPTION OF THE DRAWINGS

FIG. 1 is a block diagram of an example of a computing environment for determining characteristics of real-world objects in a virtual environment in accordance with the present disclosure.

FIG. 2 depicts an example of a hand skeleton generated by a component of the computing environment illustrated in FIG. 1.

FIG. 3 is a block diagram of an example of a process for determining characteristics of real-world objects in a virtual environment in accordance with the present disclosure.

FIG. 4A depicts an example of a user interacting with a real-world object while the process illustrated in FIG. 3 executes.

FIG. 4B depicts a virtual environment that includes the real-world object illustrated in FIG. 4A and a virtual object associated with the real-world object.

FIG. 5 illustrates another example of a user interacting with a real-world object while the process illustrated in FIG. 3 executes.

FIG. 6 illustrates yet another example of a user interacting with a real-world object while the process illustrated in FIG. 3 executes.

FIG. 7 illustrates yet another example of a user interacting with a real-world object while the process illustrated in FIG. 3 executes.

FIG. 8 illustrates yet another example of a user interacting with a real-world object while the process illustrated in FIG. 3 executes.

FIG. 9 is a block diagram of an example of a computing system for determining characteristics of real-world objects in a virtual environment in accordance with the present disclosure.

### DETAILED DESCRIPTION

Computing devices, such as wearable devices and extended reality (XR) devices, provide users an effective tool for gaming, training, education, healthcare, mobile computing, and more. An XR device merges the physical and virtual worlds, encompassing virtual reality (VR), augmented reality (AR), and mixed reality (MR) experiences. These devices can include headsets or glasses equipped with sensors, cameras, and displays that utilize users'movements and surroundings, allowing them to interact with digital content. XR devices offer immersive experiences by either completely replacing the real world with a virtual one (e.g., VR), overlaying digital information onto the real world (e.g., AR), or seamlessly integrating digital and physical elements (e.g., MR).

Users are able to interact with the virtual environment by manipulating objects (e.g., real-world objects, virtual objects, or a combination thereof), navigating menus, and triggering actions using various input methods, which are translated by the device's sensors and algorithms into corresponding digital interactions within the XR environment. Inputs to XR devices may be provided through gestures (e.g., hand movements), voice commands, controllers, eye movements, and the like.

An XR device can be configured to enhance interactions with real-world objects within the virtual environment. For example, an XR device may identify a physical, real-world object that is manipulated by a user within the virtual environment and provide information related to the real-world object. To illustrate, the XR device may be configured to provide information related to the real-world object via a virtual display, virtual user interface, or the like that is displayed within the virtual environment at a location on or nearby the real-world object.

At least one technical problem XR devices exhibit in identifying real-world objects, for example with capturing physical characteristics of real-world objects, is that such identifications are typically performed by processing image data of the real-world object (e.g., pixel image data) captured by one or more sensors of the XR device (e.g., RGB cameras). The analysis of the pixel image data may be performed with the assistance of artificial intelligence (AI), such as a machine learning model. These image data capture and analysis processes are often costly regarding compute resources, and in turn costly regarding power consumption. These compute resource and power consumption costs may undesirably impact the performance (e.g., speed, responsiveness, stability, and user experience) and/or battery life of the XR device.

At least some of the technical solutions described herein may enable devices, such as XR devices, to identify physical, real-world objects in a virtual environment without relying on the capture or processing of image data of the real-world objects. Identifying a real-world object may include capturing physical characteristics of the real-world object. In some implementations, an XR device may leverage data available to it via one or more monitoring processes continuously performed by the device. For example, the XR device may leverage dynamic hand tracking (HaT) data.

In some implementations, the systems and methods described herein may leverage data related to the position and/or orientation of one or more portions of a user, such as a hand of the user, the data provided by one or more monitoring processes of an XR device. For example, the data may indicate pose information of the user's hand. The pose information can be analyzed to identify a real-world object that the user is interacting with, for example including physical characteristics of the real-world object.

In some implementations, the systems and methods described herein may use the identified physical characteristics of the real-world object to provide information related to the real-world object to the user within the virtual environment. For example, the XR device may render a virtual object within the virtual environment that is associated with the real-world object and that provides the information about the real-world object. The systems and methods described herein may be implemented, for example, within XR or VR systems and/or devices such as head-mounted display (HMD) devices. Head-mounted devices (e.g., HMD devices) may include augmented reality (AR) glasses, virtual reality (VR) headsets, and the like. More generally, the systems and methods described herein may be implemented in any type of computing system.

At least one technical benefit of these technical solutions is reducing inefficient use of compute resources and reducing power consumption of the XR device. Compute resource and power consumption saving may reduce performance impacts associated with the XR device performing identification of real-world objects in the virtual environment and/or may extend battery life of the XR device. Improved resource usage by the XR device may in turn enable enhanced user productivity and may promote and/or sustain user immersion with the XR environment.

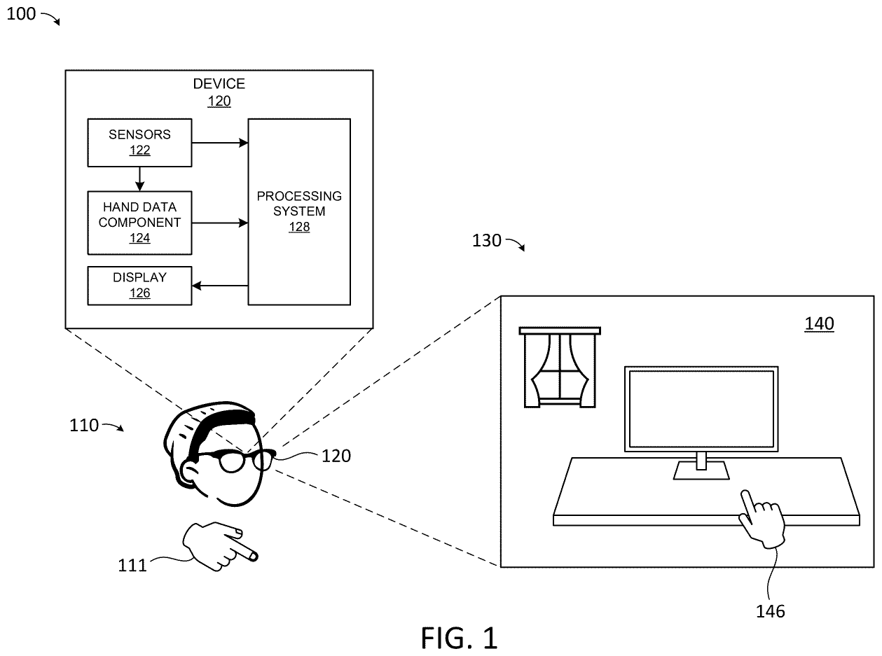

FIG. 1 illustrates an example implementation of a computing environment 100 for identifying physical characteristics of real-world objects in a virtual environment, such as an XR environment.

In the illustrated implementation, the computing environment 100 includes a user 110, a device 120, and an image 130 displayed to the user 110 by the device 120. The image 130 is a representation of an environment 140, such as an XR environment, which may include images of physical, real-world objects and virtual objects that are created, placed, and managed within the environment 140 by the device 120.

In some implementations, the device 120 may be provided as an XR device, for example a head-mounted device such as a pair of AR glasses, a VR headset device, or the like. As shown, the device 120 may be provided with components including one or more sensors 122, a hand data component 124, one or more displays 126, and a processing system 128.

In some implementations, the sensors 122 may include one or more image sensors (e.g., RGB cameras), thermal sensors (e.g., infrared imaging devices), gyroscopes, accelerometers, magnetometers, depth sensors, and audio sensors (e.g., microphones), in any combination. The sensors 122 are configured to sense and collect data relative to the user 110 and the environment 140, and to provide the data to processing system 128. In some implementations, one or more of the sensors 122, such as one or more accelerometers, gyroscopes, and/or magnetometers, may be configured to collectively function as an inertial measurement unit (IMU) of the device 120. The IMU may be configured to measure a wide range of motion, including linear acceleration, angular velocity, and orientation, for example. In some implementations, the device 120 may be configured to combine data sensed by one or more of the sensors 122.

The hand data component 124 may be configured to use data received from the sensors 122 to determine position and orientation (e.g., a rotation) information related to one or more portions of the user 110, such as one or more portions of a body of the user 110. To illustrate, the hand data component 124 may determine position and orientation information related to a hand 111 of the user 110. The hand data component 124 may simultaneously determine position and orientation information related to more than one portion of the body of the user 110, for example to both hands of the user 110, one or more portions of one or both arms of the user 110, one or more portions of one or both legs of the user, one or both feet of the user, and so on. In some implementations, data received by the hand data component 124 may be supplemented, for example by position and/or orientation information related to a portion of the body of the user 110, such as the hand 111, provided by another device communicatively coupled to the device 120, such as another wearable device worn by the user 110 (e.g., a wristband device).

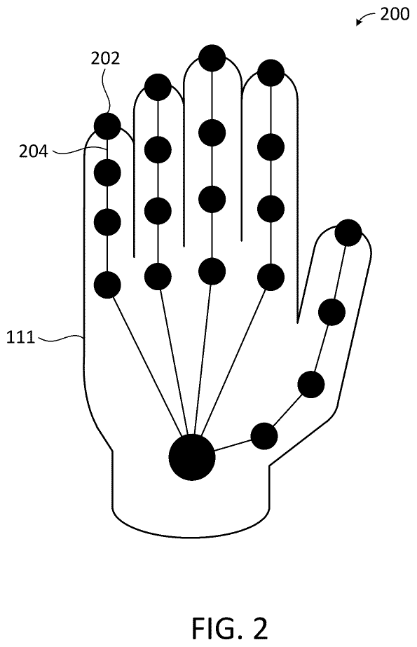

With reference also to FIG. 2, the hand data component 124 may use the position and orientation information to generate a hand skeleton 200 that represents the position and orientation of portions of the hand 111 relative to one another. The hand skeleton 200 may be made up of a plurality of features that correspond to particular portions of the hand 111, such as fingertips, joints, the palm, the wrist, and so on in any combination. For example, in accordance with the illustrated implementation, the hand skeleton 200 may be made up of a plurality of landmarks 202 that correspond to particular portions of the hand 111, such as fingertips, joints, the palm, and the wrist, in any combination. The landmarks 202 may be interconnected with corresponding vectors 204 that indicate the locations of adjacent landmarks 202 relative to one another. As shown, the hand skeleton includes twenty-one landmarks 202 and corresponding vectors 204. In other implementations, the hand skeleton 200 may include more or fewer landmarks 202 and corresponding vectors 204.

The hand data component 124 may identify the landmarks 202 using data received from the sensors 122. For example, in an implementation, the hand data component 124 identifies the landmarks 202 by processing image data received from one or more image sensors of the device 120, such as one or more cameras (e.g., RGB cameras). The hand data component 124 may process the image data to determine the landmarks 202, for example using one or more machine learning (ML) models.

For example, in an implementation the hand data component 124 uses a ML pipeline that includes two models working collaboratively. More specifically, the two models include a palm detector model and a hand landmark model. The palm detector model is configured to operate on an input image to locate at least one palm of a hand (e.g., the hand 111) using a hand bounding box that is oriented based on the real-world orientation of the hand in the image data.

The hand landmark model operates on the hand bounding box provided by the palm detector model and returns the landmarks 202. In accordance with the illustrated implementation, the hand landmark model performs precise landmark localization of twenty-one landmarks 202, for example via regression. The hand landmark model may provide the landmarks 202 using high-fidelity 2.5D coordinates. For the purposes of the present disclosure, 2.5D refers to a visual representation that appears three-dimensional, but with limited or no real-world depth in the third dimension. Each landmark 202 may include location data that locates the landmark 202 in space, for example relative to others of the landmarks 202. For example, in an implementation, the location data of a landmark 202 may include location coordinates or location features of the landmark 202. Location coordinates may include x, y, and relative depth coordinates that correspond to three-dimensional, real-world space, for example. The hand landmark model may determine the location data (e.g., coordinates) using real-world image data (e.g., received from the sensors 122) and synthetic datasets, in any combination. The hand landmark model may determine a binary classification of handedness, such as left hand or right hand.

The hand data component 124 may connect adjacent ones of the landmarks 202 with vectors 204, to generate the hand skeleton 200. The hand skeleton 200, including the landmarks 202 and the vectors 204, may represent position and orientation information of a hand (e.g., the hand 111) that may be referred to as pose of the hand in real-world, three-dimensional space. In this regard, the position and orientation information may be referred to as pose information of the hand. The palm detector model and the hand landmark model may collectively be referred to as a hand pose estimation model.

The hand data component 124 may provide the pose information (e.g., including the handedness classification) to the processing system 128. The processing system 128 may process the pose information and generate one or more graphical representations within the environment 140 that correspond to respective real-world portions of the hand. For example, as shown, the environment 140 includes a virtual hand 146 that corresponds to the hand 111 of the user 110.

The hand data component 124 may continuously receive position and orientation data from the sensors 122. The hand data component 124 may update the landmarks 202 and the vectors 204 dynamically (e.g., in real time) based on movement, such as repositioning and/or reorientation, of one or more portions of the real-world hand (e.g., the hand 111). In this regard, the hand data component 124 may dynamically update the hand skeleton 200. The hand data component 124 may provide dynamic pose information to the processing system 128, which may in turn update a corresponding pose of the virtual hand 146 in real time.

In some implementations, the hand data component 124 may further be configured to compute gestures. For example, the hand data component 124 may use an algorithm to determine a state of each finger (e.g., bent or extended), for example via accumulated angles of respective joints. The hand data component 124 may map a set of finger states to a set of one or more predefined gestures. The hand data component 124 may use this technique to estimate basic static gestures and may use a sequence of the landmarks 202 to estimate dynamic gestures.

In some implementations, the hand data component 124 may be provided as a discrete component of the device 120, such as an application-specific integrated circuit (ASIC), for example. In some implementations, the hand data component 124 comprises a digital signal processor (DSP). In some implementations, the hand data component 124 may be integrated with a hardware and/or software component of the processing system 128.

The display 126 of the device 120 may be provided as a screen or projection surface that presents immersive visual content of the environment 140 to the user 110. The display 126 may be configured to merge virtual objects with physical, real-world objects in the environment 140. Example implementations of the display 126 can include optical see-through displays on a head-mounted device (e.g., lenses of AR glasses or XR glasses) or video pass-through of a head-mounted device (e.g., screens in an MR device or VR headset device).

The processing system 128 of the device 120 may include one or more processors, such as central processing units (CPUs), graphics processing units (GPUs), specialized artificial intelligence (AI) processors, and the like. The processing system 128 may include one or more processors that reside in the device 120 (e.g., AR glasses, VR headset device, etc.), one or more processors or devices that are communicatively coupled to and share processing load with the device 120, such as processors of a mobile device (e.g., mobile phone, laptop, etc.), server processors, cloud-based processors, or the like, in any combination.

In some implementations, the processing system 128 is configured to receive pose information from the hand data component 124. The pose information may include location data for one or more landmarks 202, for example including respective x, y, and relative depth coordinates of each landmark 202. In such an implementation, the pose information received by the processing system 128 does not include image data (e.g., image data sensed by a camera) related to the hand 111 of the user 110.

The processing system 128 can interpret pose information as an indicator of respective positions and/or orientations of one or more portions of the user 110, for example one or more portions of a body of the user 110, such as the hand 111. Stated differently, in some implementations the pose information provided by the hand data component 124 comprises an indicator of an orientation of a portion of a body of the user 110, such as the hand 111 of the user 110. For example, the indicator may include information related to respective positions and/or orientations of a plurality of joints of the hand 111, information related to respective positions and/or orientations of fingertips of the hand 111, information related to a position and/or orientation of a palm of the hand 111, information related to a position and/or orientation of a wrist of the hand 111, and so on, in any combination.

The processing system 128 can analyze the pose information. Based on the results of the analysis of the indicator, the processing system 128 can identify that the user 110 is interacting with a real-world object. For example, the processing system 128 may identify that a particular pose of the hand 111 (e.g., based on respective x, y, and relative depth coordinates of one or more landmarks 202) is indicative of the user 110 interacting with a real-world object, for example as described elsewhere herein.

The processing system 128 may determine one or more characteristics (e.g., physical characteristics) of the real-world object, for example based on the pose information itself and/or based on the analysis of the pose information. In some implementations, the characteristics may include one or more dimensional characteristics of the real-world object, such as length, width, height, depth, angulation, and the like. In some implementations, the characteristics may include one or more properties (e.g., physical properties) of the real-world object, such as weight or, modulus of elasticity, for example.

The processing system 128 may perform some or all of the analysis of the pose information independently, may offload some or all of the analysis to another resource, such as a cloud resource, a server resource, a machine learning model, in any combination. For example, in some implementations, the processing system 128 may provide the pose information to a machine learning model trained on pose information of the user 110 and/or synthetic pose information. The machine learning model may be implemented as a Recurrent Neural Network (RNN), such as a Long Short-Term Memory (LSTM) or a Gated Recurrent Unit (GRU), as a Temporal Convolutional Network (TCN), or another temporal neural network. Outputs of the machine learning model may include, for example, the identification that the user 110 is interacting with a real-world object, the determination of one or more characteristics of the real-world object, a type of interaction the user is having with the real-world object (e.g., holding the object, moving the object, the like), in any combination.

In some implementations, training the machine learning model may include comprehensive data collection including a broad range of pose information and/or movements in various environments, for example labeled with event types (e.g., grip, gesture, hold, toss, squeeze, or the like). Feature extraction may be used to transform raw pose information into meaningful inputs, such as finger and or joint positions and orientations, finger, joint, and wrist movements, or a combination thereof, landmark 202 and/or vector 204 trajectories (e.g., including positions, velocity, acceleration of finger landmarks), or the like. The extracted features may be fed into the machine learning model, capturing temporal dependencies and spatial-temporal patterns. Data may be processed in a rolling buffer, with temporal windows fed into the model for real-time predictions.

In some implementations, the processing system 128 may optionally supplement the pose information with other data, for example other data provided by the sensors 122 of the device 120. For example, in an implementation the processing system 128 may receive one or more frames of image data of the environment 140 (e.g., from an RGB camera). The processing system 128 may analyze the one or more frames of image data, for example using the machine learning model, to identify what the real-world object is. Knowledge of what the real-world object is may enhance a confidence level of the machine learning model in identifying that the user 110 is interacting with the real-world object and/or in determining one or more characteristics of the real-world object, for example.

In accordance with the illustrated implementation of the computing environment 100, the device 120 displays an image 130 to the user 110 that may include physical, real-world objects in the environment 140 and/or virtual objects generated within the environment 140, for example by the processing system 128. The device 120 may also display one or more graphical representations within the environment 140 that correspond to respective real-world portions of the user 110. For example, as shown, the environment 140 includes the virtual hand 146 that corresponds to the hand 111 of the user 110. The device 120 is configured to detect and observe movement of the hand 111 of the user 110, for example using data sensed by the sensors 122 and provided by the hand data component 124, and to update the displayed position and orientation of the virtual hand 146 within the environment 140 accordingly. The position and orientation of the hand 111 of the user 110 may be referred to as a pose of the hand 111.

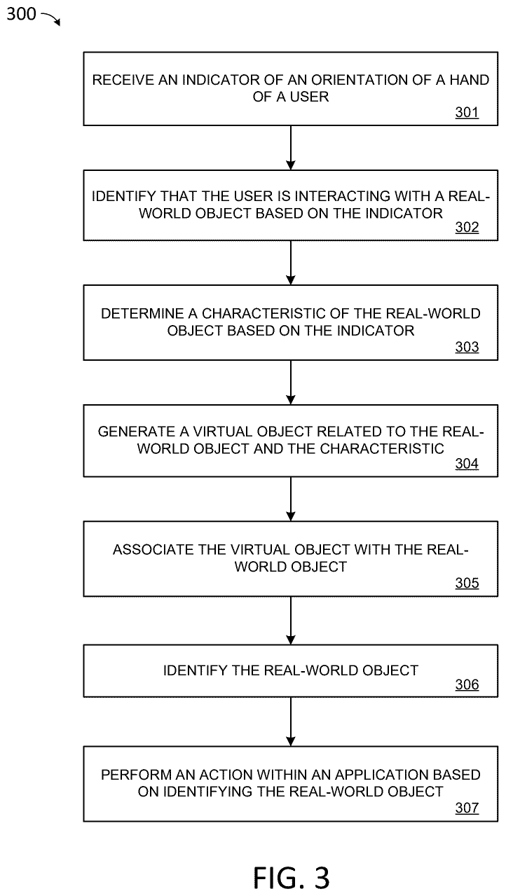

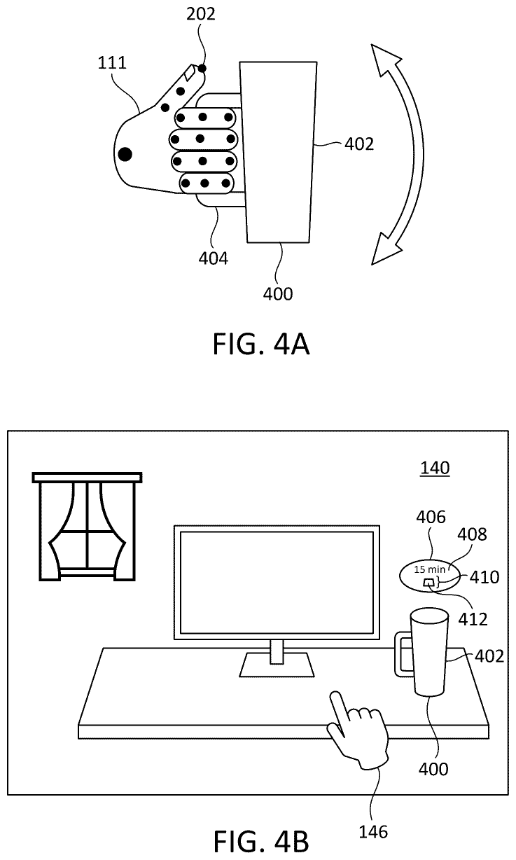

FIG. 3 is a block diagram of a process 300 for identifying that a user is interacting with a real-world object and determining physical characteristics of real-world objects in a virtual environment. For the purposes of illustration, the process 300 is described with reference to an implementation using systems and components of the computing environment 100. Additionally, FIGS. 4A-4B illustrate an example of the user 110 interacting with a real-world object as the process 300 is executing.

In some implementations, the process 300 is initiated when a corresponding mode on the device 120, such as an object measuring mode, for example, is enabled. The mode may be enabled by the user 110, for example in response to an action of the user 110, such as operating a control of a user interface, issuing a voice command, performing a gesture, or the like. Once enabled, the process 300 may continue executing until the mode is subsequently disabled by the user 110. In some implementations, the process 300 may be enabled for a predetermined interval of time, for example in response to an action of the user 110. Once the interval of time expires, execution of the process 300 automatically terminates.

In some implementations of the process 300, the device 120 may be a wearable device worn by the user 110, such as a head-mounted device (e.g., AR glasses, XR glasses, a VR headset device, or the like). As shown, the device 120 is operating and displaying the image 130 of the environment 140 to the user 110, via the display 126. The environment 140 may be an AR environment, an MR environment, an XR environment, or another type of environment, for example.

As shown in FIG. 4A, the user 110 is interacting with a real-world object 400 in the form of a cup 402 having a handle 404. The handle 404 is gripped in the hand 111 of the user 110. The illustrated arrows indicate a motion of the cup 402 as the user 110 takes a drink from it. As shown in FIG. 4B, the environment 140 includes the cup 402 and the virtual hand 146 after the user 110 has placed the cup 402 down in the environment 140, such as on a surface of a desk or table.

As the user 110 grips the handle 404 of the cup 402, moves the cup 402 to drink from it, and places the cup 402 down, the hand data component 124 may be continuously determining pose information related to the hand 111. The pose information may include the hand skeleton 200, including landmarks 202 and vectors 204. For the sake of clarity in the figures, a limited number of the landmarks 202 are depicted, and the vectors 204 are omitted.

At step 301, the process 300 receives dynamic pose information related to the position and/or orientation of the hand 111 of the user 110. The pose information is interpreted by the process 300 as an indicator of an orientation of the hand 111 of the user 110. To illustrate, the hand data component 124 provides the pose information to the processing system 128 of the device 120. The pose information includes data about the position and/or orientation of the hand skeleton 200 as it moves within the environment 140.

At step 302, the process 300 identifies, based on an analysis of the pose information (e.g., interpreted as the indicator), that the user 110 is interacting with the real-world object 400. The pose information may include location data for one or more landmarks 202, for example including respective x, y, and relative depth coordinates of each landmark 202. In such an implementation, the pose information analyzed by the process 300 does not include image data (e.g., image data sensed by a camera) related to the real-world object 400 or the hand 111 of the user 110.

The process 300 may identify that the user 110 is interacting with a real-world object using the processing system 128 and/or the machine learning model to analyze the pose information. The machine learning model may determine that the position of the landmarks 202 (e.g., including respective x, y, and relative depth coordinates of the landmarks 202) in the hand skeleton 200 is indicative of the hand 111 of the user 110 holding a real-world object, and more specifically the handle of a cup in accordance with the illustrated interaction. The machine learning model makes this determination even though the pose information does not include any information, such as image information, related to the cup 402. In this regard, the process 300 identifies that the user 110 is interacting with a cup without relying on pixel image processing and/or manipulation.

At step 303, the process 300 determines, based on the pose information (e.g., interpreted as the indicator), one or more physical characteristics of the real-world object 400. In accordance with the example interaction, the machine learning model may determine a property in the form of a weight of the cup 402.

A determination of the weight of the real-world object may be based on a strength of the hand 111 of the user 110. For example, the user 110 may optionally participate in a calibration procedure of the processing system 128. During the calibration procedure, the user 110 may be asked to measure some known values. For example, the user 110 may be asked to measure a known distance with their fingers, to pick up items with known weights, to toss the items vertically one or more times, or the like. Pose information collected during the calibration procedure may be used to train the machine learning model on a size of the hand 111, the strength of the hand 111, or the like. The calibration process may enhance the accuracy of physical characteristic determinations made by the processing system 128.

The machine learning model may determine the weight of the real-world object 400 based on a comparison of the pose information collected during interaction with the cup 402 with information from the calibration procedure. The process 300 may observe a change in the weight of the cup 402. For example, the weight of the cup 402 may decrease after the user 110 drinks from it.

At step 304, the process 300 may optionally generate a virtual object related to the real-world object 400 (e.g., the cup 402) and the determined characteristic (e.g., the weight of the cup 402). For example, in accordance with the illustrated example interaction, the process 300 generates a virtual object 406 in the form of a hydration monitor, based on identifying that the user 110 is interacting with the cup 402 and determining the weight of the cup 402.

The virtual object 406 may include a display portion 408. The display portion 408 may include information related to the real-world object 400 that it is related to, such as the cup 402. For example, as shown the hydration monitor includes a display portion 408 that displays information related to the cup 402 for the user 110, such as an elapsed time since the user 110 last drank from the cup 402.

At step 305, the process 300 may optionally associate the virtual object 406 with the real-world object 400. In some implementations, associating the virtual object 406 with the real-world object 400 includes anchoring the virtual object 406 to the real-world object 400 within the environment 140. Once anchored, the virtual object 406 may maintain its position relative to the real-world object 400 as the real-world object 400 is moved within the environment 140, for example by the user 110. To illustrate, in accordance with the illustrated example interaction, the process 300 anchors the virtual object 406 (e.g., the hydration monitor) to the cup 402 in a position that is spaced above the cup 402 within the environment 140, for example such that the hydration monitor floats above the cup 402.

In some implementations, the virtual object 406 includes a user interface portion 410 for an application related to the real-world object 400. In accordance with the illustrated example interaction, the application may be the hydration monitor. The user interface portion 410 may include one or more control elements 412. The control elements 412 may be interactive. Examples of interactive control elements include buttons, text fields, checkboxes, radio buttons, dropdown lists, sliders, date pickers, links, toggles, tabs, and the like. In an implementation, the interactive control elements may be operated by the user 110 within the environment 140, for example by interacting with them via the virtual hand 146. In accordance with the illustrated example interaction, the user 110 may provide information to the hydration monitor application by operating one of the control elements 412.

At step 306, the process 300 may optionally identify the real-world object 400. In some implementations, the process 300 identifies what the real-world object 400 is using image data, for example image data provided by the sensors 122 of the device 120. For example, the processing system 128 may analyze one or more frames of image data (e.g., provided by an RGB camera of the device 120), for example using the machine learning model, to identify that the real-world object 400 is the cup 402. Based on analysis of the image data, the processing system 128 and/or the machine learning model may identify the real-world object 400 with enhanced accuracy. For example, in accordance with the illustrated example interaction, the machine learning model may determine that the cup 402 is a water cup, for example as opposed to a coffee cup.

At step 307, the process 300 may optionally perform an action within an application based on identifying the real-world object 400. For example, in accordance with the illustrated example interaction, the process 300 may perform an action within the hydration tracker based on the identification of the cup 402 as a water cup. To illustrate, the process 300 may provide an indication to the hydration tracker to monitor a volume of water consumed by the user 110 (e.g., based on changes in the weight of the cup 402). In response to the indication from the process 300, the hydration tracker may monitor and compare the volume of water consumed from the cup 402 by the user 110 with a predetermined volume (e.g., such as a daily consumption goal), and may update the user 110 on progress toward the goal, for example via the display portion 408.

FIG. 5 illustrates another example of the user 110 interacting with a real-world object as the process 300 is executing. As shown, the user 110 is interacting with a real-world object 500 having at least one portion with angular geometry. The user 110 desires to measure an angle α between a first side 502 and an opposed second side 504 of the real-world object 500 using the process 300.

As shown, the user 110 aligns respective digits of the hand 111 with portions of the real-world object 500 between which the angle should be measured. More specifically, the user 110 extends the thumb of the hand 111 aligns it with the first side 502 of the real-world object 500 and extends the index finger of the hand 111 and aligns it with the second side 504. As the user 110 extends the thumb and index finger, the hand data component 124 may be continuously determining pose information related to the hand 111. The pose information may include the hand skeleton 200, including landmarks 202 and vectors 204. For the sake of clarity in the figures, a limited number of the landmarks 202 are depicted, and the vectors 204 are omitted.

At step 302, the process 300 identifies, based on the pose information (which the process 300 interprets as an indicator of an orientation of the hand 111 of the user 110), that the user 110 is interacting with the real-world object 500 and desires to determine a characteristic, specifically an angulation measurement, of the real-world object 500. The process 300 may make this determination by the processing system 128 analyzing the pose information, for example using the machine learning model. The machine learning model may determine that respective positions and/or orientations of the landmarks 202 (e.g., including respective x, y, and relative depth coordinates of the landmarks 202) in the hand skeleton 200 are indicative of measuring an angular portion of a real-world object using the hand 111. The machine learning model makes this determination even though the pose information does not include any information, such as image information, related to the real-world object 500. In this regard, the process 300 identifies that the user 110 is interacting with the real-world object 500 without relying on pixel image processing and/or manipulation.

At step 303, the process 300 determines, based on the pose information, one or more physical characteristics of the real-world object 500. In accordance with the example interaction, the processing system 128 and/or the machine learning model may determine a first vector 205 that aligns with one or more landmarks 202 of the thumb of the hand 111 and a second vector 207 that aligns with one or more landmarks 202 of the index finger. The processing system 128 determines the angle α between the first vector 205 and the second vector 207. The processing system 128 may present the angulation measurement for the user 110 within the environment 140, for example via the display 126. In an implementation, the angulation measurement may be overlaid on a surface of the real-world object 500 within the environment 140.

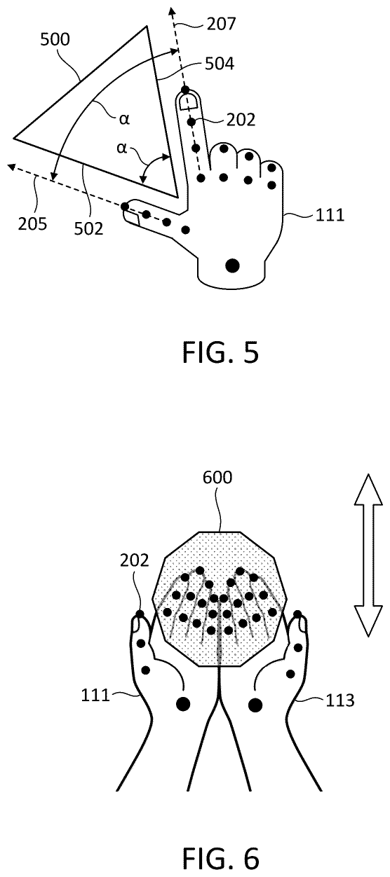

FIG. 6 illustrates yet another example of the user 110 interacting with a real-world object as the process 300 is executing. As shown, the user 110 is holding a real-world object 600 in the hand 111 and a hand 113. The user 110 desires to measure the elasticity of the real-world object 600 using the process 300.

The user 110 may toss the real-world object 600 in the air one or more times and catch the real-world object 600 in the hand 111 and/or the hand 113 again as it falls. For example, the user 110 may toss the real-world object 600 upward along a trajectory that aligns with the illustrated arrows. As the user 110 holds the real-world object 600 in the hand 111 and the hand 113 and tosses the real-world object 600 one or more times, the hand data component 124 may be continuously determining pose information related to the hand 111 and the hand 113. The pose information may include a respective hand skeleton 200 for each of the hand 111 and the hand 113, including corresponding landmarks 202 and vectors 204. For the sake of clarity in the figures, a limited number of the landmarks 202 are depicted, the vectors 204 are omitted, and the real-world object 600 is illustrated as transparent to expose landmarks 202 that would otherwise not be visible in the drawing.

At step 302, the process 300 identifies, based on the pose information (which the process 300 interprets as an indicator of an orientation of the hand 111 of the user 110), that the user 110 is interacting with the real-world object 600 and desires to determine a characteristic, specifically an elasticity property, of the real-world object 500. The process 300 may make this determination by the processing system 128 analyzing the pose information, for example using the machine learning model. The machine learning model may determine that the positions and/or orientations of the landmarks 202 (e.g., including respective x, y, and relative depth coordinates of the landmarks 202) in the hand skeletons 200 are indicative of determining an elasticity of a real-world object using the hand 111 and the hand 113. The machine learning model makes this determination even though the pose information does not include any information, such as image information, related to the real-world object 600. In this regard, the process 300 identifies that the user 110 is interacting with the real-world object 600 without relying on pixel image processing and/or manipulation.

At step 303, the process 300 determines, based on the pose information, one or more physical characteristics of the real-world object 600. In accordance with the example interaction, the processing system 128 and/or the machine learning model may analyze one or more portions of the pose information that are related to movements of the hand 111 and the hand 113 collected while the user 110 tossed the real-world object 600. Based on the analysis, the process 300 may determine an elasticity value that applies to the real-world object 600. The processing system 128 may present information related to the elasticity of the real-world object 600 for the user 110 within the environment 140, for example via the display 126.

At step 306, the process 300 may optionally identify the real-world object 600. In some implementations, the process 300 identifies what the real-world object 600 is using image data, for example image data provided by the sensors 122 of the device 120. In an example interaction, the processing system 128 may analyze one or more frames of image data (e.g., provided by an RGB camera of the device 120), for example using the machine learning model, to determine what the real-world object 600 is. Based on analysis of the image data, the processing system 128 and/or the machine learning model may identify the real-world object 600 with enhanced accuracy. For example, in accordance with the illustrated example interaction, the machine learning model may determine that the real-world object 600 comprises a particular variety of edible produce.

The processing system 128 may analyze results of the pose information analysis, the elasticity measurement, and the variety of the produce to estimate freshness data for the produce. The processing system 128 may present information related to the freshness data for the user 110 within the environment 140, for example via the display 126. In an implementation, the freshness data may be overlaid on a surface of the real-world object 600 within the environment 140.

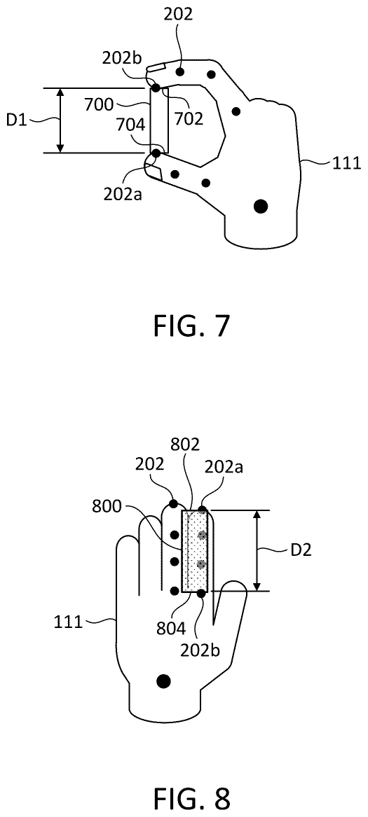

FIG. 7 illustrates yet another example of the user 110 interacting with a real-world object as the process 300 is executing. As shown, the user 110 is interacting with a real-world object 700. The user 110 desires to measure a distance between two locations on the real-world object 700. For example, in accordance with the illustrated interaction, the user 110 desires to measure a length from a first end 702 to an opposed second end 704 of the real-world object 700 using the process 300.

As shown, the user 110 holds the real-world object 700 between the index finger of the hand 111 and the thumb of the hand 111. More specifically, the first end 702 of the real-world object 700 abuts the tip of the index finger and the second end 704 of the real-world object 700 abuts the tip of the thumb. The hand data component 124 may determine pose information related to the hand 111. The pose information may include the hand skeleton 200, including landmarks 202 and vectors 204. For the sake of clarity in the figures, a limited number of the landmarks 202 are depicted, and the vectors 204 are omitted.

At step 302, the process 300 identifies, based on the pose information (which the process interprets as an indicator of an orientation of the hand 111 of the user 110), that the user 110 is interacting with the real-world object 700 and desires to determine a characteristic, specifically a distance measurement (e.g., length measurement), of the real-world object 700. The process 300 may make this determination by the processing system 128 analyzing the pose information, for example using the machine learning model. The machine learning model may determine that respective positions and/or orientations of the landmarks 202 in the hand skeleton 200 (e.g., including respective x, y, and relative depth coordinates of the landmarks 202) are indicative of measuring a distance between two locations on the real-world object 700. The machine learning model may make this determination, for example, based on substantial alignment of the tip of the index finger with the tip of the thumb and/or the position of at least one joint of a plurality of joints of the hand 111 relative to the real-world object 700. The machine learning model makes this determination even though the pose information does not include any information, such as image information, related to the real-world object 700. In this regard, the process 300 identifies that the user 110 is interacting with the real-world object 700 without relying on pixel image processing and/or manipulation.

At step 303, the process 300 determines, based on the pose information, one or more physical characteristics of the real-world object 700. In accordance with the example interaction, the processing system 128 and/or the machine learning model may determine a distance D1 from a first landmark 202a associated with the tip of the thumb of the hand 111 to a second landmark 202b associated with the tip of the index finger. In this regard, determining the characteristic of the real-world object 700 is based on a distance between a first joint and a second joint of a plurality of joints of the hand 111, relative to the real-world object 700. The distance D1 may be determined, for example, based on location data (e.g., x, y, and relative depth coordinates) of the first landmark 202a and the second landmark 202b determined from analysis of the pose information. The processing system 128 may present the distance measurement for the user 110 within the environment 140, for example via the display 126. In an implementation, the distance measurement may be overlaid on a surface of the real-world object 700 within the environment 140.

FIG. 8 illustrates yet another example of the user 110 interacting with a real-world object as the process 300 is executing. As shown, the user 110 is interacting with a real-world object 800. The user 110 desires to measure a distance between two locations on the real-world object 800. For example, in accordance with the illustrated interaction, the user 110 desires to measure a length from a first end 802 to an opposed second end 804 of the real-world object 800 using the process 300.

As shown, the user 110 holds the hand 111 flat and rests the real-world object 800 upon it. The hand data component 124 may determine pose information related to the hand 111. The pose information may include the hand skeleton 200, including landmarks 202 and vectors 204. For the sake of clarity in the figures, a limited number of the landmarks 202 are depicted, the vectors 204 are omitted, and the real-world object 800 is illustrated as transparent to expose landmarks 202 that would otherwise not be visible in the drawing.

At step 302, the process 300 identifies, based on the pose information (which the process interprets as an indicator of an orientation of the hand 111 of the user 110), that the user 110 is interacting with the real-world object 800 and desires to determine a characteristic, specifically a distance measurement (e.g., length measurement), of the real-world object 800. The process 300 may make this determination by the processing system 128 analyzing the pose information, for example using the machine learning model. The machine learning model may determine that respective positions and/or orientations of the landmarks 202 (e.g., including respective x, y, and relative depth coordinates of the landmarks 202) in the hand skeleton 200 are indicative of measuring a distance between two locations on the real-world object 800. The machine learning model may make this determination, for example, based on the fingers and thumb of the hand 111 being extended and held together. The machine learning model makes this determination even though the pose information does not include any information, such as image information, related to the real-world object 800. In this regard, the process 300 identifies that the user 110 is interacting with the real-world object 800 without relying on pixel image processing and/or manipulation.

At step 303, the process 300 determines, based on the pose information, one or more physical characteristics of the real-world object 800. In accordance with the example interaction, the processing system 128 may receive and analyze one or more frames of image data (e.g., provided by an RGB camera of the device 120), for example using the machine learning model, to identify an outer boundary of the real-world object 800. The processing system 128 and/or the machine learning model may compare the outer boundary of the real-world object 800 with location data (e.g., x, y, and relative depth coordinates) of one or more landmarks 202 of the hand skeleton 200. For example, the processing system 128 and/or the machine learning model may determine that the first end 802 of the real-world object 800 is located proximate to a first landmark 202a and the second end 804 is located proximate to a second landmark 202b.

The processing system 128 and/or the machine learning model may determine a distance D2 from the first landmark 202a to the second landmark 202b, for example, based on location data (e.g., x, y, and relative depth coordinates) of the first landmark 202a and the second landmark 202b determined from analysis of the pose information. The processing system 128 may equate the distance D2 with a distance measurement from the first end 802 of the real-world object 800 to the second end 804. The processing system 128 may present the distance measurement for the user 110 within the environment 140, for example via the display 126. In an implementation, the distance measurement may be overlaid on a surface of the real-world object 800 within the environment 140.

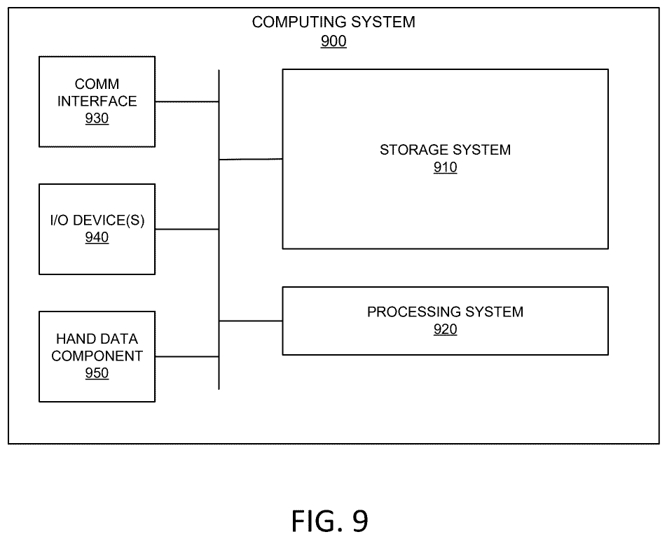

FIG. 9 illustrates a computing system 900 to determine physical characteristics of real-world objects in a virtual environment according to an implementation. Computing system 900 represents any apparatus, computing system, or systems with which the various operational architectures, processes, scenarios, and sequences are disclosed herein for providing determining physical characteristics of real-world objects in a virtual environment can be implemented. Computing system 900 can be provided as an AR device, an XR device, a wearable device, or another computing device capable of the operations described herein. For example, the computing system 900 may be implemented as the device 120.

As shown, the computing system 900 includes a storage system 910, a processing system 920, a communication interface 930, input/output (I/O) device(s) 940, and a hand data component 950. The hand data component 950 can be provided as the hand data component 124 of the device 120, for example. The processing system 920 is operatively linked to the communication interface 930, the I/O device(s) 940, and the storage system 910. In some implementations, the communication interface 930 and/or the I/O device(s) 940 may be communicatively linked to the storage system 910. The computing system 900 may further include other components such as a battery and an enclosure that are not shown for clarity.

The communication interface 930 includes components that communicate over communication links, such as network cards, ports, radio frequency, processing circuitry (and corresponding software), or some other communication devices. The communication interface 930 may be configured to communicate over metallic, wireless, or optical links. The communication interface 930 may be configured to use Time Division Multiplex (TDM), Internet Protocol (IP), Ethernet, optical networking, wireless protocols, communication signaling, or some other communication format-including combinations thereof. The communication interface 930 may be configured to communicate with external devices, such as servers, user devices, or other computing devices.

The I/O device(s) 940 may include peripherals of a computer that facilitate the interaction between the user 110 and the computing system 900. Examples of the I/O device(s) 940 may include keyboards, mice, trackpads, monitors, displays, printers, cameras, microphones, external storage devices, sensors, and the like. In some implementations, the I/O device(s) 940 includes a see-through or video pass-through display providing a view of the physical environment, such as the display 126. In some implementations, the computing system 900 can include at least one camera, such as an RGB camera and/or a depth camera that captures image data, for example related to a pose of a portion of the user 110, such as a hand.

The storage system 910 may include volatile and nonvolatile, removable, and non-removable media implemented in any method or technology for storage of information, such as computer-readable instructions, data structures, program modules, or other data. The storage system 910 may be implemented as a single storage device but may also be implemented across multiple storage devices or sub-systems. The storage system 910 may include additional elements, such as a controller to read operating software from the storage systems. Examples of storage media (also referred to as computer-readable storage media or a computer-readable storage medium) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal. The computer-readable storage medium may have program instructions stored thereon.

The processing system 920 can include microprocessor circuitry (e.g., at least one processor) and other circuitry that retrieves and executes operating software (i.e., program instructions) from the storage system 910. The processing system 920 may comprise the processing system 128. In some implementations, the processing system 920 can include external computing resources, such as those provided by another device in communication with the computing system 900, cloud processing resources, or the like that are accessible to the computing system 900 via the communication interface 930.

The processing system 920 may be mounted on a circuit board that may also hold the storage system 910. Operating software of the storage system 910 may include computer programs, firmware, or some other form of machine-readable program instructions. The operating software on the storage system 910 may further include an operating system, utilities, drivers, network interfaces, applications, or some other type of software. When read and executed by processing system 920, the operating software on the storage system 910 directs the computing system 900 to operate as described herein. In at least one implementation, the operating software can provide the process 300. The operating software can provide or cause at least one processor to manage actions associated with physical objects as described herein.

In at least one implementation, the processing system 920 receives pose information related to a portion of the user 110, such as the hand 111 of the user 110, from the hand data component 950. The processing system 920 analyzes the pose information to identify that the user 110 is interacting with a real-world object and/or to determine a characteristic of the real-world object. Additionally, the processing system may generate a virtual object related to the real-world object and the characteristic and may associate the virtual object with the real-world object. In some implementations, the processing system 920 presents information related to the determined characteristic to the user 110, for example via the I/O device(s) 940. In some implementations, the processing system 920 provides information related to the real-world object and/or the determined characteristic to an application, for example via the communication interface 930.

Clause 1. A method comprising: receiving an indicator of an orientation of a hand of a user; identifying, based on the indicator, that the user is interacting with a real-world object; determining, based on the indicator, a characteristic of the real-world object; generating a virtual object related to the real-world object and the characteristic; and associating the virtual object with the real-world object.

Clause 2. The method of clause 1, wherein the indicator includes information related to respective positions of a plurality of joints of the hand, the respective positions sensed by a head-mounted device worn by the user.

Clause 3. The method of clause 2, wherein determining the characteristic of the real-world object is based on a position of at least one joint of the plurality of joints relative to the real-world object.

Clause 4. The method of clause 2, wherein determining the characteristic of the real-world object is based on a distance between a first joint and a second joint of the plurality of joints, relative to the real-world object.

Clause 5. The method of clause 2, further comprising: identifying the real-world object based on image data received from the head-mounted device.

Clause 6. The method of clause 5, further comprising: performing an action within an application based on identifying the real-world object.

Clause 7. The method of clause 1, wherein the virtual object includes a display portion that includes information related to the real-world object.

Clause 8. The method of clause 1, wherein the virtual object includes a user interface portion that includes a control element for an application related to the real-world object.

Clause 9. The method of clause 1, wherein the indicator is related to a pose of the hand.

Clause 10. The method of clause 1, wherein identifying that the user is interacting with the real-world object includes processing the indicator using a machine learning model.

Clause 11. The method of clause 1, wherein associating the virtual object with the real-world object includes anchoring the virtual object to the real-world object.

Clause 12. A computing system comprising: a computer-readable storage media; at least one processor operatively coupled to the computer-readable storage media; and program instructions stored on the computer-readable storage media that, when executed by the at least one processor, direct the at least one processor to perform a method, the method comprising: receiving an indicator of an orientation of a hand of a user; identifying, based on the indicator, that the user is interacting with a real-world object; determining, based on the indicator, a characteristic of the real-world object; generating a virtual object related to the real-world object and the characteristic; and associating the virtual object with the real-world object.

Clause 13. The computing system of clause 12, wherein the indicator includes information related to respective positions of a plurality of joints of the hand, the respective positions sensed by a head-mounted device worn by the user.

Clause 14. The computing system of clause 13, wherein determining the characteristic of the real-world object is based on a position of at least one joint of the plurality of joints relative to the real-world object.

Clause 15. The computing system of clause 12, wherein the virtual object includes a display portion that includes information related to the real-world object.

Clause 16. The computing system of clause 12, wherein the virtual object includes a user interface portion that includes a control element for an application related to the real-world object.

Clause 17. A computer-readable storage medium having program instructions stored thereon that, when executed by at least one processor, direct the at least one processor to perform a method comprising: receiving an indicator of an orientation of a hand of a user; identifying, based on the indicator, that the user is interacting with a real-world object; determining, based on the indicator, a characteristic of the real-world object; generating a virtual object related to the real-world object and the characteristic; and associating the virtual object with the real-world object.

Clause 18. The computer-readable storage medium of clause 17, wherein the indicator includes information related to respective positions of a plurality of joints of the hand, the respective positions sensed by a head-mounted device worn by the user, and wherein determining the characteristic of the real-world object is based on a distance between a first joint and a second joint of the plurality of joints, relative to the real-world object.

Clause 19. The computer-readable storage medium of clause 17, wherein the virtual object includes a user interface portion that includes a control element for an application related to the real-world object.

Clause 20. The computer-readable storage medium of clause 17, wherein the virtual object includes a display portion that includes information related to the real-world object.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data, such as information related to portions of a user's body and/or surrounding environment, may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

It should be appreciated that logic flows depicted in the figures, such as the process 300 shown in FIG. 3, do not require the particular order shown, or sequential order, to achieve desirable results. In addition, other steps may be provided, or steps may be eliminated, from the described flows, and other components may be added to, or removed from, the described systems. Accordingly, other implementations are within the scope of the claims.

It should further be appreciated that the abilities of the process 300 to identify that a user is interacting with a real-world object and/or to determine characteristics of the real-world object are not limited to being based on the hand poses or gestures illustrated herein, and that the systems and methods described herein may perform the process 300 based on other suitable hand poses and/or gestures.

What is claimed is:

1. A method comprising:
receiving an indicator of an orientation of a portion of a user;
identifying, based on the indicator, that the user is interacting with a real-world object;
determining, based on the indicator, a characteristic of the real-world object;
generating a virtual object related to the real-world object and the characteristic; and
associating the virtual object with the real-world object.

2. The method of claim 1, wherein the portion of the user is a hand of the user, and wherein the indicator includes information related to respective positions of a plurality of joints of the hand, the respective positions sensed by a head-mounted device worn by the user.

3. The method of claim 2, wherein determining the characteristic of the real-world object is based on a position of at least one joint of the plurality of joints relative to the real-world object.

4. The method of claim 2, wherein determining the characteristic of the real-world object is based on a distance between a first joint and a second joint of the plurality of joints, relative to the real-world object.

5. The method of claim 2, further comprising:
identifying the real-world object based on image data received from the head-mounted device.

6. The method of claim 5, further comprising:
performing an action within an application based on identifying the real-world object.

7. The method of claim 1, wherein the virtual object includes a display portion that includes information related to the real-world object.

8. The method of claim 1, wherein the virtual object includes a user interface portion that includes a control element for an application related to the real-world object.

9. The method of claim 1, wherein the portion of the user is a hand of the user, and wherein the indicator is related to a pose of the hand.

10. The method of claim 1, wherein identifying that the user is interacting with the real-world object includes processing the indicator using a machine learning model.

11. The method of claim 1, wherein associating the virtual object with the real-world object includes anchoring the virtual object to the real-world object.

12. A computing system comprising:
a computer-readable storage media;
at least one processor operatively coupled to the computer-readable storage media;
and program instructions stored on the computer-readable storage media that, when executed by the at least one processor, direct the at least one processor to perform a method, the method comprising:
receiving an indicator of an orientation of a portion of a user;
identifying, based on the indicator, that the user is interacting with a real-world object;
determining, based on the indicator, a characteristic of the real-world object;
generating a virtual object related to the real-world object and the characteristic; and
associating the virtual object with the real-world object.

13. The computing system of claim 12, wherein the portion of the user is a hand of the user, and wherein the indicator includes information related to respective positions of a plurality of joints of the hand, the respective positions sensed by a head-mounted device worn by the user.

14. The computing system of claim 13, wherein determining the characteristic of the real-world object is based on a position of at least one joint of the plurality of joints relative to the real-world object.

15. The computing system of claim 12, wherein the virtual object includes a display portion that includes information related to the real-world object.

16. The computing system of claim 12, wherein the virtual object includes a user interface portion that includes a control element for an application related to the real-world object.

17. A computer-readable storage medium having program instructions stored thereon that, when executed by at least one processor, direct the at least one processor to perform a method comprising:
receiving an indicator of an orientation of a portion of a user;
identifying, based on the indicator, that the user is interacting with a real-world object;
determining, based on the indicator, a characteristic of the real-world object;
generating a virtual object related to the real-world object and the characteristic; and
associating the virtual object with the real-world object.

18. The computer-readable storage medium of claim 17, wherein the portion of the user is a hand of the user, and wherein the indicator includes information related to respective positions of a plurality of joints of the hand, the respective positions sensed by a head-mounted device worn by the user, and wherein determining the characteristic of the real-world object is based on a distance between a first joint and a second joint of the plurality of joints, relative to the real-world object.

19. The computer-readable storage medium of claim 17, wherein the virtual object includes a user interface portion that includes a control element for an application related to the real-world object.

20. The computer-readable storage medium of claim 17, wherein the virtual object includes a display portion that includes information related to the real-world object.
